(19) United States
(12) Patent Application Publication
(10) Pub. No.: US 2022/0309611 A1
(43) Pub. Date: Sep. 29, 2022

(54) TRAINING DEVICE, PROCESSING SYSTEM, TRAINING METHOD, PROCESSING METHOD, AND STORAGE MEDIUM

(71) Applicant: KABUSHIKI KAISHA TOSHIBA, Tokyo (JP)

(72) Inventor: Toshikazu TAKI, Yokohama (JP)

(73) Assignee: KABUSHIKI KAISHA TOSHIBA, Tokyo (JP)

(21) Appl. No.: 17/654,096

(22) Filed: Mar. 9, 2022

(30) Foreign Application Priority Data
Mar. 24, 2021 (JP) 2021-049516

(51) Int. Cl. G06T 3/40; G06T 3/00; G06K 9/62

(52) U.S. Cl. CPC G06T 3/4046; G06T 3/0043; G06K 9/6256

(57) ABSTRACT

According to one embodiment, a training device is configured to use a first image to generate a second image. A meter is visible in the first image. The meter includes a pointer and a plurality of graduations. The pointer is relatively rotated with respect to the plurality of graduations in the second image. The training device is further configured to use the second image to train a first model that processes a meter image.

### CROSS-REFERENCE TO RELATED APPLICATIONS

This application is based upon and claims the benefit of priority from Japanese Patent Application No. 2021-049516, filed on Mar. 24, 2021; the entire contents of which are incorporated herein by reference.

### FIELD

Embodiments described herein relate generally to a training device, a processing system, a training method, a processing method, and a storage medium.

### BACKGROUND

Technology exists in which an indication of a meter is read from an image. It is effective to use an image processing model to improve the robustness of the reading. Technology that can reduce the burden of a user when training the model is desirable.

### BRIEF DESCRIPTION OF THE DRAWINGS

FIG. 1 is a schematic view illustrating a configuration of a training device according to a first embodiment;

FIGS. 2A to 2D are schematic views for describing the processing of the training device according to the embodiment;

FIGS. 3A to 3E are images for describing the processing of the training device according to the embodiment;

FIGS. 4A to 4F are images for describing the processing of the training device according to the embodiment;

FIG. 5 is a flowchart illustrating a training method according to the embodiment;

FIG. 6 is a schematic view illustrating a configuration of a processing system according to a second embodiment;

FIG. 7 is a flowchart illustrating a processing method according to the second embodiment;

FIGS. 8A and 8B are flowcharts illustrating reading methods according to the second embodiment;

FIG. 9 is a schematic view illustrating a configuration of a processing system according to a modification of the second embodiment;

FIG. 10 is a flowchart illustrating a processing method according to the modification of the second embodiment;

FIG. 11 is a flowchart illustrating a processing method according to the modification of the second embodiment; and

FIG. 12 is a schematic view illustrating a hardware configuration.

### DETAILED DESCRIPTION

According to one embodiment, a training device is configured to use a first image to generate a second image. A meter is visible in the first image. The meter includes a pointer and a plurality of graduations. The pointer is relatively rotated with respect to the plurality of graduations in the second image. The training device is further configured to use the second image to train a first model that processes a meter image.

Various embodiments are described below with reference to the accompanying drawings. In the specification and drawings, components similar to those described previously or illustrated in an antecedent drawing are marked with like reference numerals, and a detailed description is omitted as appropriate.

### First Embodiment

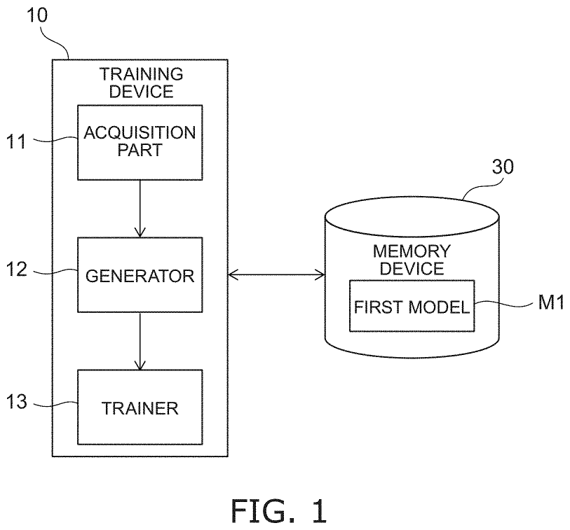

FIG. 1 is a schematic view illustrating a configuration of a training device according to a first embodiment.

The training device 10 trains a first model that processes a meter image. A meter that includes a pointer is visible in the meter image. The training device 10 includes an acquisition part 11, a generator 12, and a trainer 13.

The meter is an analog meter. The meter includes a pointer that rotates, multiple graduations arranged around a rotation center of the pointer, and multiple characters marked to correspond to at least a portion of the multiple graduations. The multiple graduations may be arranged in a circular configuration, or may be arranged in an arc-like configuration. The multiple graduations and the multiple characters are marked on a display panel. The outer rim of the display panel, the outer frame of the meter, etc., are circles or circular shapes (e.g., ellipses, ovals, etc.). The outer rim of the display panel and the outer frame of the meter may be quadrilateral. The characters are, for example, numerals.

The type of the meter is arbitrary. For example, the meter is a thermometer, a hygrometer, a pressure gauge, an ammeter, a voltmeter, a wattmeter, a frequency meter, a speedometer, etc. The indication of the meter indicates a temperature, a humidity, a pressure value, a current value, a voltage value, an electrical power value, a frequency, or a speed.

The acquisition part 11 acquires the position of a pointer region that includes a pointer in a first image in which the meter is visible. The first image is one type of meter image. For example, the acquisition part 11 processes the first image to extract the pointer region from the first image. The acquisition part 11 may receive the position of the pointer region obtained by another processing device. The position of the pointer region may be designated by a user.

The acquisition part 11 acquires the position of the rotation center of the pointer in the first image. For example, the acquisition part 11 acquires the position of the rotation center designated by the user. The acquisition part 11 may input the first image to an image processing model and acquire the rotation center from the output result of the image processing model. The image processing model is trained to identify the rotation center of the pointer from the meter image. The acquisition part 11 may receive the position of the rotation center obtained by another processing device.

The generator 12 uses the first image to generate a second image in which the pointer is relatively rotated with respect to the multiple graduations. For example, the generator 12 erases the pointer from the first image. The generator 12 synthesizes the pointer that is rotated around the rotation center into the first image in which the pointer was erased. The second image in which the pointer is rotated with respect to the multiple graduations is obtained thereby. The generator 12 may rotate the first image around the rotation center after erasing the pointer from the first image. The erased pointer is synthesized into the rotated first image. The second image in which the multiple graduations are rotated with respect to the meter is obtained thereby. The pointer is relatively rotated with respect to the multiple graduations by some technique.

The erasing can include methods such as an algorithm utilizing the Navier-Stokes equations, the fast marching method, Deep Image Prior, etc. In the synthesizing, the pixels of a portion of the first image in which the pointer was erased are replaced with the pixels of the pointer image. When synthesizing, disturbance components such as reflections, etc., may be removed beforehand. The disturbance components may be added to the second image after generating the second image by using the first image in which the disturbance components are removed. Filtering of the image after the synthesis may be performed to relax the discontinuity between the pointer and the other regions in the image. For example, a Gaussian filter, a median filter, or the like is used. The angle of the pointer in the second image is different from the angle of the pointer in the first image. The generator 12 stores the second image in a memory device 30.

The trainer 13 acquires a first model M1 that is stored in the memory device 30. The trainer 13 uses the second image to train the first model M1 that processes the meter image. The trainer 13 stores the trained first model M1 in the memory device 30.

For example, the first model M1 identifies the pointer region of the meter according to the input of the meter image. The first model M1 includes a neural network and performs segmentation. It is favorable for the first model M1 to include a convolutional neural network (CNN). A teaching image of the pointer region in the second image is used when training. The trainer 13 trains the first model M1 by using the second image as input data and by using the teaching image as teacher data.

The first model M1 may identify the indication of the meter according to the input of the meter image. In such a case as well, it is favorable for the first model M1 to include a CNN. The indication in the second image is used as the teacher data when training. The trainer 13 trains the first model M1 by using the second image as the input data and by using the indication as the teacher data.

Advantages of the embodiment will now be described.

Conventionally, the indication of a meter is read based on the extraction result of the image processing that extracts the pointer region, the scale region, and the character region. The robustness of the read processing has room for improvement in conventional methods. For example, the accuracy of the reading decreases when the meter is unclear in the meter image. Low resolution, large noise (large fluctuation of the luminance), blow-out, black-out, another object overlapping a portion of the meter, etc., are examples of being unclear.

To improve the robustness, it is effective to use a model for processing the meter image. By using a model, the accuracy of the reading can be improved even for the cases described above. On the other hand, many images are necessary to train the model. Much time is necessary for a human to image meters and prepare images for training.

For this problem, the training device 10 according to the embodiment uses the first image in which the meter is visible to generate the second image in which the pointer is rotated. Then, the training device 10 uses the second image to train the first model M1 that processes the meter image. According to the embodiment, images that already exist can be used to generate other images for training. The burden on the user that prepares the images for training when training the model can be reduced thereby.

For example, the training device 10 uses the first image to generate multiple second images in which the angles of the pointers are different from each other. The training device 10 uses the second images to sequentially train the first model M1. The training device 10 also may use the first image to train the first model M1.

The embodiment will now be described more specifically.

The acquisition part 11 may perform preprocessing. The preprocessing includes not less than one selected from cutting out, detecting the rotation center, correcting, extracting the regions, and associating. For example, the acquisition part 11 cuts out the first image from an overall image in which objects other than the meter are visible. The acquisition part 11 detects the rotation center of the pointer. The acquisition part 11 corrects the distortion of the first image. The acquisition part 11 extracts the pointer region, the scale region, and the character region from the first image. The acquisition part 11 respectively associates the indications and the possible angles of the pointer. The preprocessing will now be elaborated.

### Cutout

The acquisition part 11 extracts candidates of regions in which meters are visible from the overall image. For example, the acquisition part 11 binarizes the overall image after converting the overall image into grayscale. The acquisition part 11 performs edge detection. The acquisition part 11 calculates the surface areas of regions that are surrounded with edges. When multiple edges are detected, the surface area of each region is calculated. The acquisition part 11 compares each calculated surface area with a prescribed threshold and selects only the regions of which the surface area is not less than the threshold. Also, the acquisition part 11 detects the shapes of the contours. The acquisition part 11 excludes the candidate when the shape of the contour of the candidate is not circular or quadrilateral. The acquisition part 11 determines that meters are visible in the remaining candidate regions. The acquisition part 11 cuts out a portion of the overall image that includes such a region as the first image.

### Detection of Rotation Center

The acquisition part 11 recognizes the multiple graduations of the meter based on the luminance difference in the first image. Typically, the graduations are line segments that extend toward the center of the meter. The acquisition part 11 generates straight lines along the graduations. The acquisition part 11 detects the region at which the intersections of the multiple straight lines are clustered as the rotation center.

### Correction

The acquisition part 11 recognizes the outer frame of the meter by performing edge detection of the first image. For example, the outer frame of the meter is a quadrilateral. The acquisition part 11 corrects the first image so that the outer frame of the meter is a rectangle. Projective transformation is favorable for the correction. When performing the projective transformation, the rotation center of the pointer can be used as the center of a polar coordinate system. The distortion of the first image is reduced by the correction. When the shape of the outer frame of the meter is not a quadrilateral, the acquisition part 11 generates a quadrilateral that circumscribes the outer frame of the meter. The acquisition part 11 corrects the first image so that the quadrilateral becomes a rectangle.

### Region Extraction

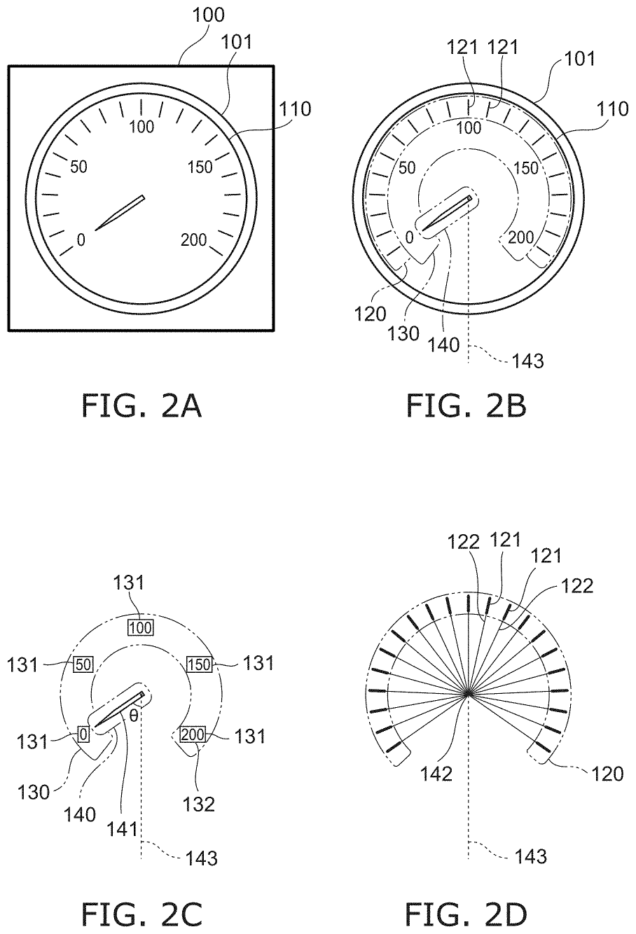

FIGS. 2A to 2D are schematic views for describing the processing of the training device according to the embodiment.

As illustrated in FIG. 2A, the acquisition part 11 extracts a display panel region 110 of a meter 101 from a first image 100. Typically, graduations and characters are marked in the display panel of the meter; and the pointer overlaps the display panel. As illustrated in FIG. 2B, the acquisition part 11 subdivides the display panel region 110 into a scale region 120 in which the graduations exist, a character region 130 in which the characters exist, and a pointer region 140 in which the pointer exists.

For example, after performing edge detection of the first image, the acquisition part 11 extracts the roundest edge by a Hough transform. The acquisition part 11 extracts the region positioned at the outer circumference portion of the extracted circle as the scale region 120. The acquisition part 11 recognizes multiple graduations 121 from the luminance difference in the scale region 120.

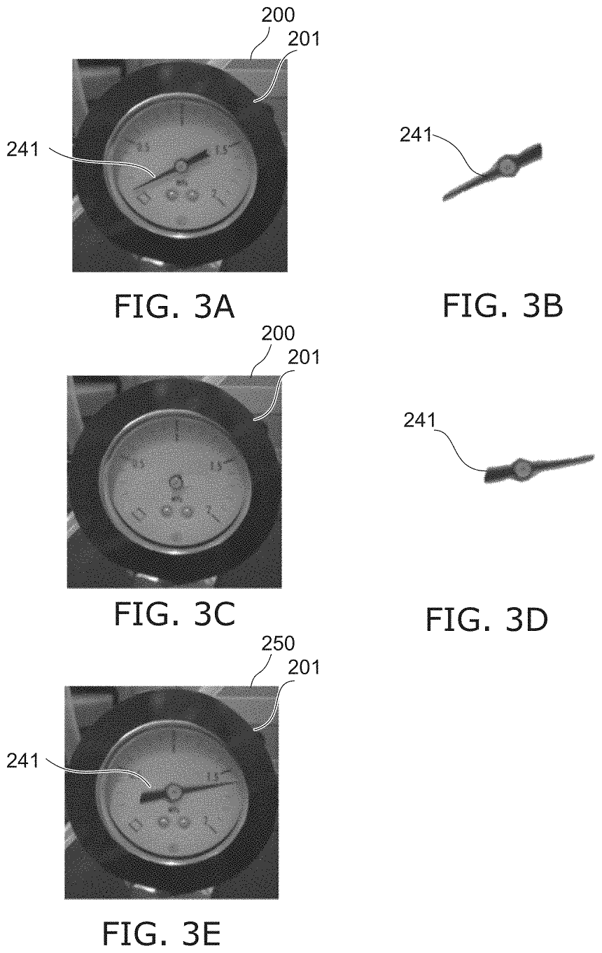

The acquisition part 11 extracts the character region 130 that includes the multiple characters from a region positioned inward of the scale region 120. As illustrated in FIG. 3C, the acquisition part 11 cuts out multiple rectangles 131 that include characters from the character region 130. The acquisition part 11 recognizes characters 132 included in the rectangles 131.

The acquisition part 11 extracts a region inward of the scale region 120 in which an edge that corresponds to a pointer 141 is detected as the pointer region 140.

### Association

The acquisition part 11 generates a reference line 143 in the display panel region 110. The reference line 143 is a straight line that extends directly downward from the rotation center. As illustrated in FIG. 2D, the acquisition part 11 generates straight lines 122 along the graduations 121 in the scale region 120. Also, the acquisition part 11 detects the region at which the intersections of the straight lines 122 are clustered as a rotation center 142 of the pointer 141. The acquisition part 11 generates the reference line 143 that extends directly downward from the rotation center 142.

The acquisition part 11 calculates an angle θ between the pointer 141 and the reference line 143 included in the pointer region 140. Also, the acquisition part 11 calculates angles between the reference line 143 and the straight lines 122. The angles of the straight lines 122 correspond to the angles of the graduations 121. The acquisition part 11 associates the characters 132 with the angles of the graduations 121. The acquisition part 11 associates the indication and each angle of the pointer 141 from the correspondence of the characters 132 and the angles of the graduations 121.

The generator 12 may use data obtained by the preprocessing when generating the second image. For example, the generator 12 acquires the recognition result of the graduations 121. The generator 12 sets the range of the angles at which the graduations 121 are recognized as the rotation range of the pointer 141. The generator 12 relatively rotates the pointer 141 with respect to the multiple graduations 121 so that the pointer 141 is positioned within the rotation range. Second images that are more suited to training can be obtained by relatively rotating the pointer 141 within the rotation range.

The generator 12 may generate teaching data for training. When the first model M1 identifies the pointer region, the generator 12 generates a teaching image of the region of the pointer in the second image when generating the second image. When the first model M1 identifies the indication of the meter from the meter image, the generator 12 calculates the value indicated by the rotated pointer based on the correspondence between the indication and the angle of the pointer 141 generated by the acquisition part 11.

Because the teaching data is generated by the generator 12, it is unnecessary for the user to prepare teaching data. The burden of the user when training the model can be further reduced thereby.

The generator 12 may deform the second image. The generator 12 distorts the second image by projective transformation. The generator 12 may deform the second image by changing the aspect ratio of the second image. The trainer 13 uses the distorted second image to train the first model M1.

For example, the generator 12 generates multiple second images in which angles of the pointers are different from each other. The generator 12 deforms the multiple second images under different conditions. As a result, multiple second images in which the aspect ratios are different from each other are generated.

The meter is not limited to being imaged from a position that squarely faces the meter. The meter in the image is distorted when the meter is imaged from a position that is oblique to the meter. When the outer rim of the actual display panel is a circle, the outer rim of the display panel is an ellipse in the distorted image. By using distorted second images to train the first model M1, the first model M1 also is able to appropriately process distorted meter images. The robustness of the reading can be further improved thereby.

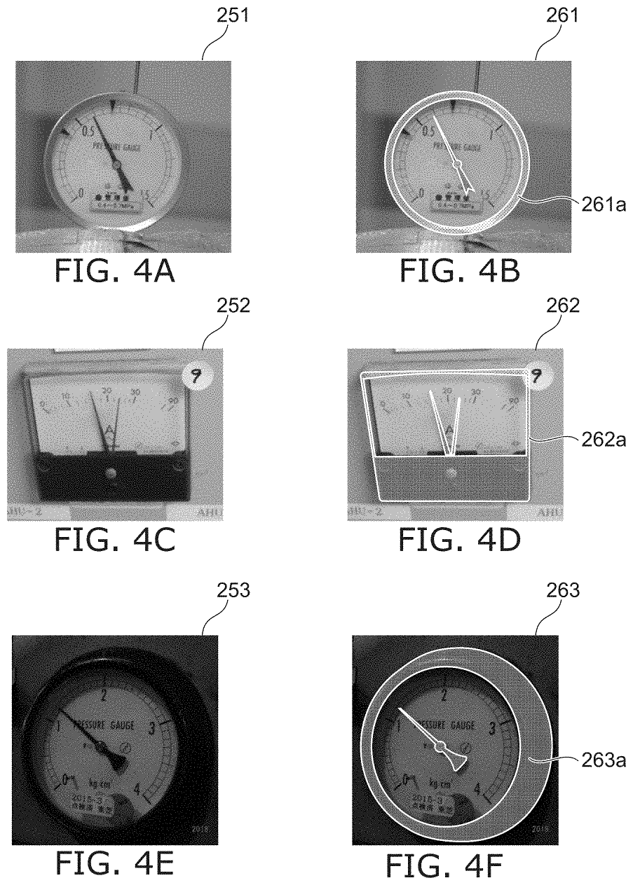

FIGS. 3A to 3E and FIGS. 4A to 4F are images for describing the processing of the training device according to the embodiment.

FIG. 3A is an example of the first image. A meter 201 is visible in a first image 200 illustrated in FIG. 3A. The meter 201 includes a pointer 241. The acquisition part 11 acquires the region of the pointer 241 in the first image 200. As illustrated in FIG. 3B, the acquisition part 11 extracts the pointer 241 from the first image.

As illustrated in FIG. 3C, the generator 12 erases the pointer 241 from the first image 200. As illustrated in FIG. 3D, the generator 12 rotates the pointer 241 within the rotation range of the pointer 241. The generator 12 generates a second image 250 illustrated in FIG. 3E by synthesizing the pointer 241 illustrated in FIG. 3D into the first image 200 illustrated in FIG. 3C.

FIG. 4A, FIG. 4C, and FIG. 4E are other examples of second images. Teaching images 261 to 263 illustrated in FIG. 4B, FIG. 4D, and FIG. 4F correspond respectively to second images 251 to 253 of FIG. 4A, FIG. 4C, and FIG. 4E. In FIG. 4B, FIG. 4D, and FIG. 4F, the pointer and the outer frame of the meter are shown by annotations 261a to 263a. The annotations are labels assigned by the user to train the first model. The generator 12 generates the teaching images 261 to 263 when generating the second images 251 to 253. The trainer 13 uses the sets of the second image and the teaching image to sequentially train the first model.

The meter may include multiple pointers. When the first model M1 identifies multiple pointers from the image, it is favorable for the first model M1 to be able to discriminate and identify each pointer. When the first model M1 identifies multiple indications from the image, it is favorable for the first model M1 to be able to discriminate and identify the indication of each pointer. For example, the first model M1 performs instance segmentation. By instance segmentation, each pointer can be discriminated and identified, or the indication of each pointer can be discriminated and identified.

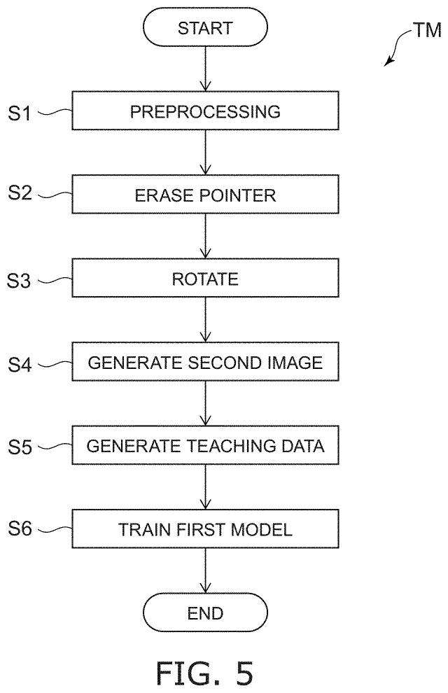

FIG. 5 is a flowchart illustrating a training method according to the embodiment.

The training device 10 performs the training method TM illustrated in FIG. 5. The acquisition part 11 performs preprocessing (step S1). The generator 12 erases the pointer from the first image (step S2). The generator 12 rotates the extracted pointer relative to the multiple graduations (step S3). The generator 12 generates a second image (step S4). The generator 12 generates teaching data (step S5). The trainer 13 uses the second image and the teaching data to train the first model M1 (step S6). The sequence of the steps of the training method TM are modifiable as appropriate. For example, step S3 may be performed before step S2 or may be simultaneously performed with step S2. Step S5 may be performed before step S4 or may be simultaneously performed with step S4.

### Second Embodiment

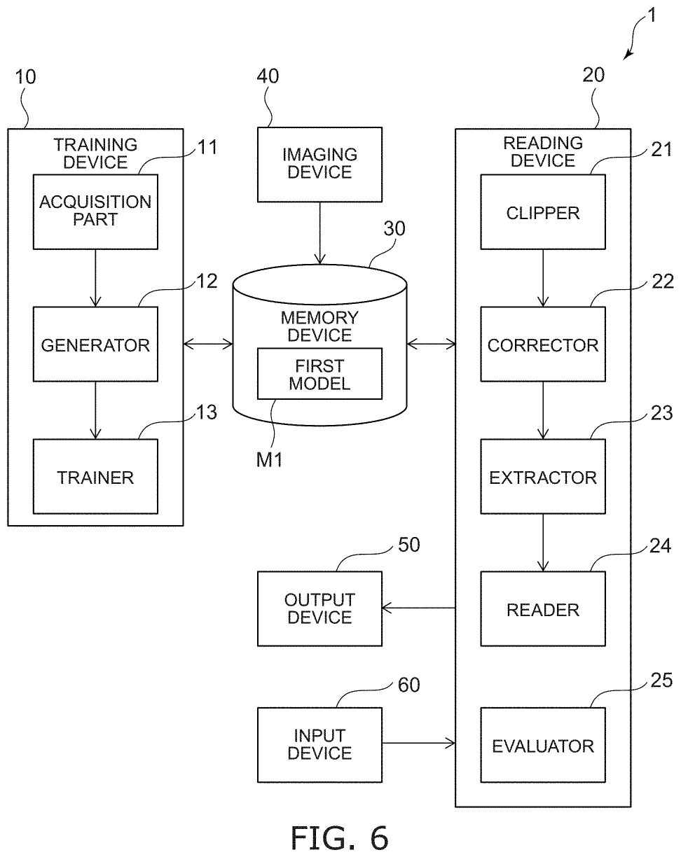

FIG. 6 is a schematic view illustrating a configuration of a processing system according to a second embodiment.

The processing system 1 includes the training device 10, a reading device 20, the memory device 30, an imaging device 40, an output device 50, and an input device 60. The imaging device 40 images the meter and generates an image. The reading device 20 reads the indication of the meter from the image. The training device 10 uses the data obtained by the processing of the reading device 20 to train the first model M1.

The reading device 20 includes a clipper 21, a corrector 22, an extractor 23, and a reader 24. The clipper 21 cuts out the first image from the overall image in which objects other than the meter are visible. The corrector 22 corrects the first image and reduces the distortion of the first image. The extractor 23 extracts the scale region, the character region, and the pointer region from the first image. The reader 24 associates the indications and the possible angles of the pointer based on the extraction result of the scale region and the character region. The reader 24 calculates the indication of the meter based on the result of the association and the extraction result of the pointer region. The processing by the clipper 21, the corrector 22, the extractor 23, and the reader 24 is performed using the method described in the first embodiment.

The reading device 20 appropriately stores, in the memory device 30, the data obtained in the processing such as the first image that is cut out, the extraction result of the regions, the correspondence of the angles and the indications, etc. The training device 10 acquires, from the memory device 30, the data obtained by the processing of the reading device 20. The training device 10 uses the acquired data to generate the second image. The training device 10 uses the second image to train the first model M1.

An evaluator 25 evaluates the accuracy of the first model M1. Specifically, an evaluation value of the accuracy of the first model M1 is calculated. For example, a higher evaluation value indicates a higher accuracy of the first model M1. The evaluator 25 calculates the evaluation value by the following method. The evaluator 25 selects an image in which the indication is already read by the reading device 20. The evaluator 25 inputs the selected image to the first model M1 and acquires the output result of the first model M1. The evaluator 25 calculates a higher evaluation value as the match improves between the data obtained by the reading device 20 and the output result of the first model M1.

For example, when the first model M1 identifies the pointer region of the meter, the evaluator 25 compares the pointer region extracted by the extractor 23 and the pointer region identified by the first model M1. The evaluator 25 calculates a higher evaluation value as the proportion of the matching surface areas of the pointer regions increases. Or, the evaluator 25 may compare the angle of the pointer based on the processing of the extractor 23 and the angle of the pointer based on the processing of the first model M1. The evaluator 25 calculates a higher evaluation value as the angle difference decreases. When the first model M1 identifies the indication of the meter, the evaluator 25 compares the indication read by the reader 24 and the indication identified by the first model M1. The evaluator 25 calculates a higher evaluation value as the indication difference decreases.

It is favorable for the increase rate of the evaluation value to increase as the match ratio increases. For example, the relationship between the evaluation value and the match ratio is represented by a second-order or higher-order function. Or, the evaluator 25 may generate a probability distribution based on the output result of the first model M1 and a probability distribution based on the data of the reading device 20. The evaluator 25 calculates the evaluation value based on the probability distribution difference. For example, the evaluator 25 generates a normal distribution centered around the angle or the indication obtained from the reading device 20 as a first probability distribution. The evaluator 25 generates a normal distribution centered around the angle or the indication obtained from the first model M1 as a second probability distribution. The first probability distribution and the second probability distribution may be represented by a histogram. The evaluator 25 calculates a higher evaluation value as the match improves between the first probability distribution and the second probability distribution. The result of using the Bhattacharyya coefficient or the like to evaluate the difference between the first probability distribution and the second probability distribution may be used as the evaluation value.

The evaluator 25 may calculate the evaluation value of the first model M1 by using the correct input from the user. The reading device 20 transmits, to the output device 50, the meter image input to the first model M1. The output device 50 outputs the meter image to the user. The input device 60 accepts the correct input from the user. The evaluator 25 calculates a higher evaluation value as the match improves between the correct input and the angle or the indication obtained from the first model M1. In such a case, as described above, it is favorable for the increase rate of the evaluation value to increase as the match ratio increases. Or, the evaluation value may be calculated by using the first and second probability distributions that use the correct angle or indication. When the evaluation value does not satisfy a first condition that is described below, the training device 10 may use the meter image input to the first model M1 and the correct input from the user to train the first model M1.

The evaluator 25 determines whether or not the evaluation value satisfies a preset first condition. For example, a threshold is set as the first condition. When a higher evaluation value indicates a higher accuracy of the first model M1, the evaluator 25 determines whether or not the evaluation value is greater than the threshold. When the evaluation value is determined to satisfy the first condition, the reading device 20 uses the first model M1 in the subsequent reading. When the first model M1 identifies the pointer region of the meter, the extractor 23 inputs the first image to the first model M1 and acquires the pointer region from the output of the first model M1. When the first model M1 identifies the indication of the meter, the reader 24 inputs the first image to the first model M1 and acquires the indication. In such a case, the processing of the extractor 23 may be omitted.

According to the processing system 1 according to the second embodiment, the first model M1 can be trained while performing the reading by the image processing. Thereby, it is unnecessary for the user to prepare the first image for the training. After the first model M1 is sufficiently trained, the first model M1 is automatically applied to the reading. The robustness of the reading can be improved by the application of the first model M1.

For example, even when a portion of the graduations or a portion of the characters cannot be recognized in the meter image, the graduations or the characters that cannot be recognized can be estimated and interpolated from the other graduations or the other characters. The number of pointers is low compared to the multiple marks of the graduations and the characters. Normally, one value is indicated by one pointer. It is difficult to read the indication when the pointer region is inappropriately extracted and the pointer cannot be recognized. By extracting the pointer region by using the first model M1 that identifies the pointer region, the accuracy of the extraction of the pointer region can be increased even when a portion of the pointer region is unclear. Also, when using the first model M1 that identifies the indication, the accuracy of the indication can be increased even when a portion of the meter is unclear. As a result, the robustness of the reading can be improved.

The imaging device 40 may acquire a video image. The imaging device 40 cuts out a still image in which the meter is visible from the video image. The reading device 20 may output the indication that is read to the output device 50. The user may use the input device 60 to input an evaluation of the output indication to the reading device 20. For example, the reading device 20 stores the indication when the evaluation of the indication is affirmative. When the evaluation of the indication is negative, the reading device 20 re-performs the reading of the indication for the meter image. Or, the reading device 20 may request the user to input the correct indication and may output the indication input from the user to the output device 50.

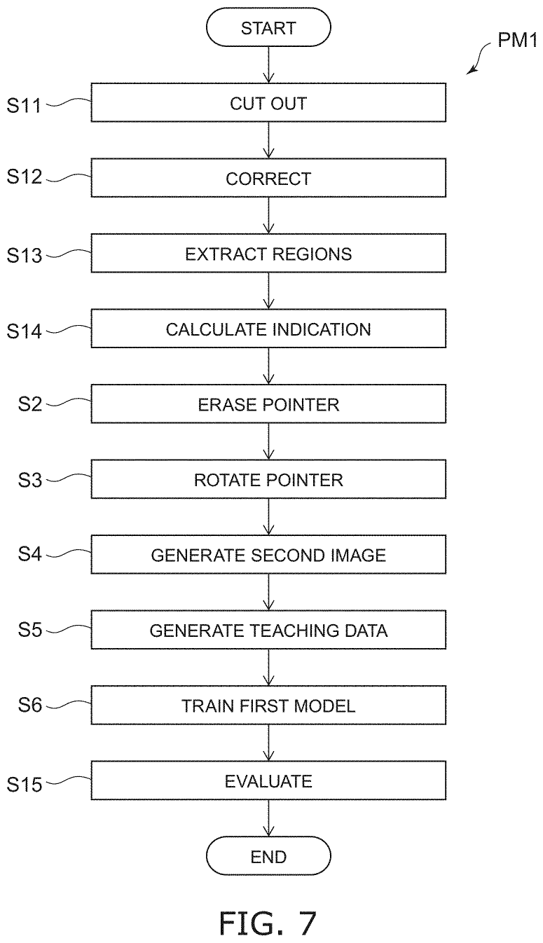

FIG. 7 is a flowchart illustrating a processing method according to the second embodiment.

When a new image is generated by the imaging device 40, the processing system 1 performs the processing method PM1 illustrated in FIG. 7. The clipper 21 cuts out the first image from the overall image (step S11). The corrector 22 corrects the first image (step S12). The extractor 23 extracts the scale region, the character region, and the pointer region from the first image (step S13). The reader 24 calculates the indication of the meter (step S14). Subsequently, steps S2 to S6 are performed similarly to the training method TM illustrated in FIG. 5. The evaluator 25 evaluates the first model (step S15).

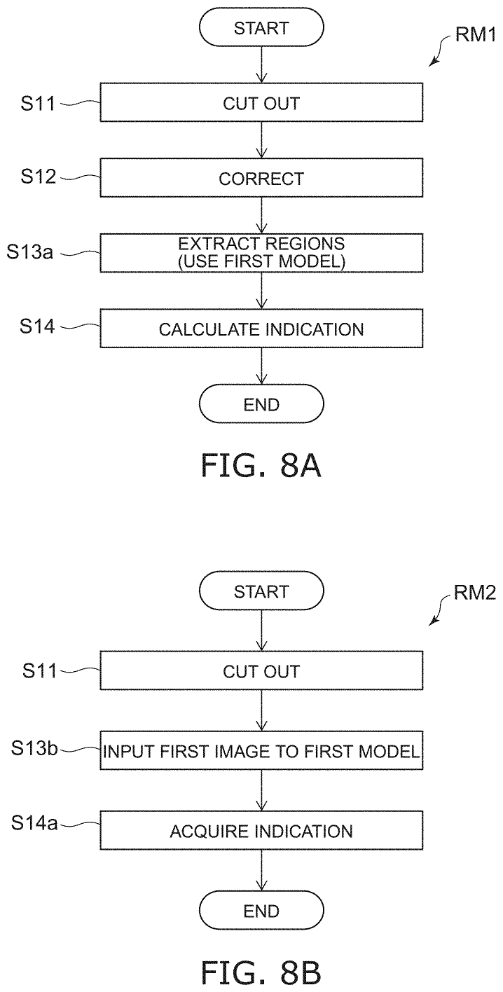

FIGS. 8A and 8B are flowcharts illustrating reading methods according to the second embodiment.

A reading method RM1 or RM2 illustrated in FIG. 8A or FIG. 8B is performed after the evaluation value is determined to satisfy the first condition in step S15 of the processing method PM1 illustrated in FIG. 7.

The reading method RM1 illustrated in FIG. 8A is performed when the first model M1 identifies the pointer region of the meter. Steps S11 and S12 are performed similarly to the processing method PM1 illustrated in FIG. 7. The extractor 23 extracts the scale region and the character region and uses the first model of the pointer region to extract the pointer region (step S13a). The reader 24 calculates the indication of the meter (step S14).

The reading method RM2 illustrated in FIG. 8B is performed when the first model M1 identifies the indication of the meter. Step S11 is performed similarly to the processing method PM1 illustrated in FIG. 7. The reader 24 inputs the first image to the first model M1 (step S13b). The reader 24 acquires the indication output from the first model M1 (step S14a).

According to the processing system 1 according to the second embodiment, the reading method can be switched as appropriate according to the progress of the training of the first model M1. The robustness of the read processing can be improved by switching to the application of the first model M1. Also, it is unnecessary for the user to set the switch to the use of the first model M1.

After the indication is obtained in the reading method RM1 or RM2, steps S2 to S6 of the processing method PM1 illustrated in FIG. 7 also may be performed. The accuracy of the first model M1 can be further increased thereby.

### Modification

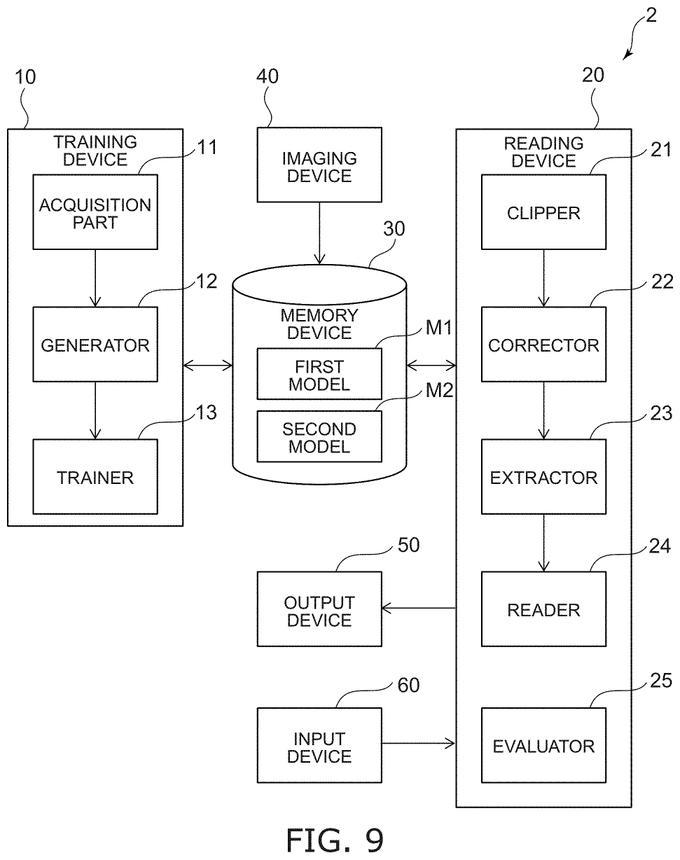

FIG. 9 is a schematic view illustrating a configuration of a processing system according to a modification of the second embodiment.

In the processing system 2 according to the modification illustrated in FIG. 9, the two models of the first model M1 and a second model M2 are used. The first model M1 identifies the pointer region of the meter from the meter image. The second model M2 identifies the indication of the meter from the meter image. The training device 10 uses the data obtained by the processing of the reading device 20 to train the first model M1 and the second model M2.

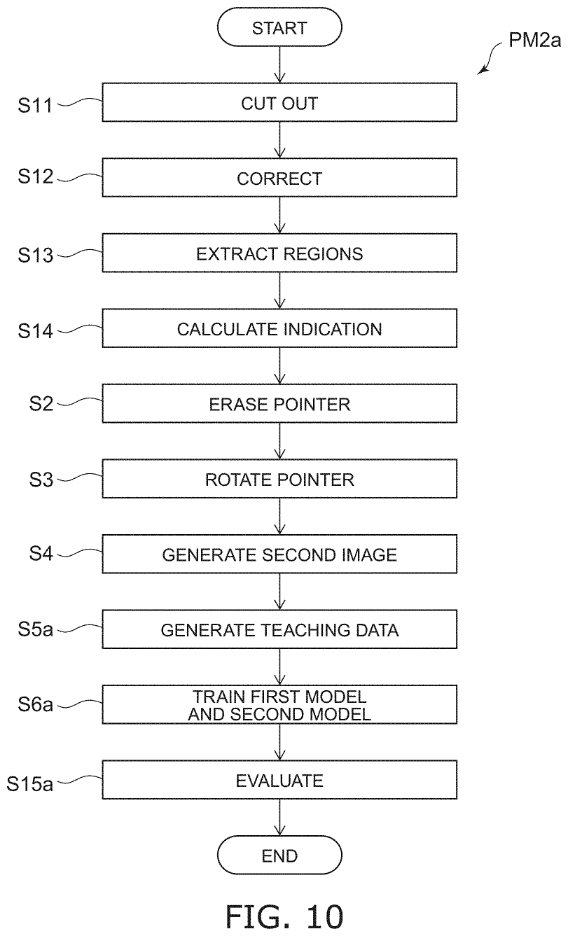

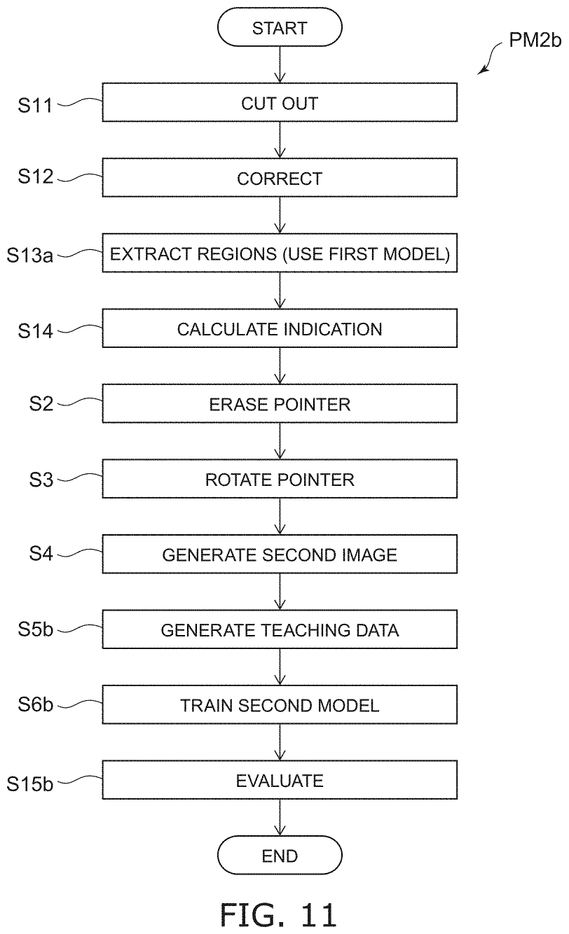

FIGS. 10 and 11 are flowcharts illustrating processing methods according to the modification of the second embodiment.

The processing system 2 performs the processing methods PM2a and PM2b illustrated in FIGS. 10 and 11. First, the processing system 2 performs the processing method PM2a. Steps S11 to S14 and S2 to S4 are performed similarly to the processing method PM1 illustrated in FIG. 7. The generator 12 generates the teaching image for training the first model M1 and the indication for training the second model M2 (step S5a). The trainer 13 uses the second image and the teaching image to train the first model M1, and uses the second image and the indication to train the second model M2 (step S6a).

The evaluator 25 evaluates the first model M1 (step S15a). The evaluator 25 calculates the first evaluation value for evaluating the accuracy of the first model M1. The evaluator 25 determines whether or not the first evaluation value satisfies the first condition. The accuracy of the first model M1 is determined to be sufficient when the first evaluation value satisfies the first condition. The evaluator 25 also may evaluate the second model M2. However, the accuracy of the second model M2 is difficult to improve compared to the accuracy of the first model M1. To shorten the processing time, the evaluator 25 may evaluate only the first model M1.

After the first evaluation value satisfies the first condition, the processing system 2 performs the processing method PM2b. Steps S11 to S14 are performed similarly to the reading method RM1 illustrated in FIG. 8A. Steps S2 to S4 are performed similarly to the processing method PM2a illustrated in FIG. 10. The generator 12 generates the indication for training the second model M2 (step S5b). The trainer 13 uses the second image and the indication to train the second model M2 (step S6b).

The evaluator 25 evaluates the second model M2 (step S15b). The evaluator 25 calculates the second evaluation value for evaluating the accuracy of the second model M2. The evaluator 25 determines whether or not the second evaluation value satisfies a preset second condition. The accuracy of the second model M2 is determined to be sufficient when the second evaluation value satisfies the second condition. For example, a second threshold is set as the second condition. When a higher second evaluation value indicates a higher accuracy of the second model M2, the evaluator 25 determines whether or not the second evaluation value is greater than the second threshold.

After the second evaluation value satisfies the second condition, similarly to the reading method RM2 illustrated in FIG. 8B, the reading device 20 inputs the first image to the second model M2 and acquires the indication from the output of the second model M2.

A teaching image for training the first model M1 also may be generated in step S5b of the processing method PM2b. The first model M1 also may be trained in step S6b. The accuracy of the first model M1 can be further increased thereby. Steps S2 to S6b of the processing method PM2b also may be performed after performing the reading method RM2. The accuracy of the second model M2 can be further increased thereby.

According to the processing system 2 according to the modification, the reading method can be switched as appropriate according to the progress of the training of the first and second models M1 and M2. The robustness of the reading can be improved by switching to the application of the first model M1. The robustness of the reading can be further improved by switching to the application of the second model M2. Also, it is unnecessary for the user to set the switch to the use of the first model M1 or the second model M2.

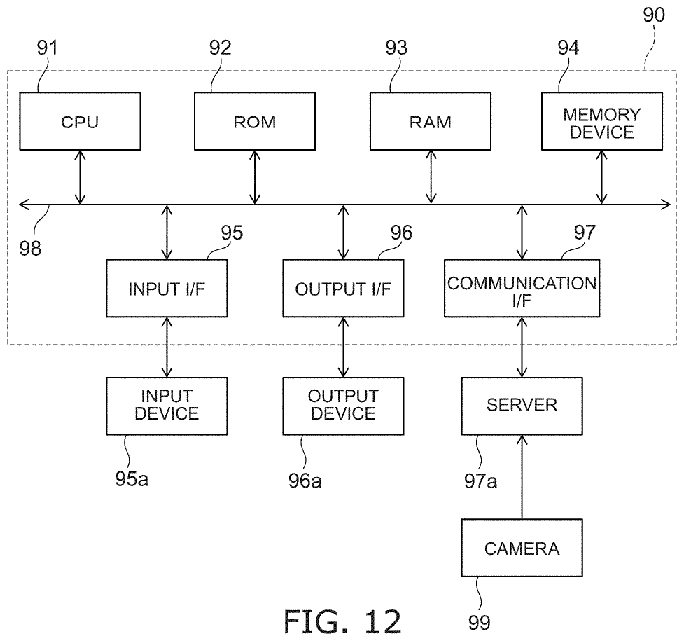

FIG. 12 is a schematic view illustrating a hardware configuration.

For example, the training device 10 and the reading device 20 have the hardware configuration illustrated in FIG. 17. A processing device 90 illustrated in FIG. 17 includes a CPU 91, ROM 92, RAM 93, a memory device 94, an input interface 95, an output interface 96, and a communication interface 97.

The ROM 92 stores programs that control the operations of a computer. Programs that are necessary for causing the computer to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the memory device 94. When executing the programs, the CPU 91 executes various processing by controlling configurations via a system bus 98.

The memory device 94 stores data necessary for executing the programs and/or data obtained by executing the programs.

The input interface (I/F) 95 connects the processing device 90 and an input device 95a. The input I/F 95 is, for example, a serial bus interface such as USB, etc. The CPU 91 can read various data from the input device 95a via the input I/F 95.

The output interface (I/F) 96 connects the processing device 90 and an output device 96a. The output I/F 96 is, for example, an image output interface such as Digital Visual Interface (DVI), High-Definition Multimedia Interface (HDMI (registered trademark)), or the like, a serial bus interface such as USB, etc. The CPU 91 can output the data to the output device 96a via the output I/F 96.

The communication interface (I/F) 97 connects the processing device 90 and a server 97a that is outside the processing device 90. The communication I/F 97 is, for example, a network card such as a LAN card, etc. The CPU 91 can read various data from the server 97a via the communication I/F 97. A camera 99 images articles and stores the images in the server 97a.

The memory device 94 includes not less than one selected from a hard disk drive (HDD) and a solid state drive (SSD). The input device 95a includes not less than one selected from a mouse, a keyboard, a microphone (audio input), and a touchpad. The output device 96a includes not less than one selected from a monitor, a projector, a printer, and a speaker. A device such as a touch panel that functions as both the input device 95a and the output device 96a may be used.

The memory device 94 and the server 97a function as the memory device 30. The input device 95a functions as the input device 60. The output device 96a functions as the output device 50. The camera 99 functions as the imaging device 40.

For example, the camera 99 is mounted in a smart device such as a smartphone, a tablet, or the like, an automatic guided vehicle (AGV), or a drone and images the meter. The camera 99 may be fixed at a position from which the meter is visible.

Two processing devices 90 may function respectively as the training device 10 and the reading device 20. One processing device 90 may function as the training device 10 and the reading device 20. The functions of the training device 10 or the reading device 20 may be realized by the collaboration of multiple processing devices 90.

By using the training device, the processing system, the training method, or the processing method described above, the burden on the user preparing the data for training can be reduced. Similar effects can be obtained by using a program for causing the computer to operate as the training device.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or a recording medium (non-transitory computer-readable storage medium) that can be read by another non-temporary computer.

For example, information that is recorded in the recording medium can be read by a computer (or an embedded system). The recording format (the storage format) of the recording medium is arbitrary. For example, the computer reads the program from the recording medium and causes the CPU to execute the instructions recited in the program based on the program. In the computer, the acquisition (or the reading) of the program may be performed via a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. The above embodiments can be practiced in combination with each other.

What is claimed is:

1. A training device, configured to:
use a first image to generate a second image, a meter being visible in the first image, the meter including a pointer and a plurality of graduations, the pointer being relatively rotated with respect to the plurality of graduations in the second image; and
use the second image to train a first model that processes a meter image.

2. The training device according to claim 1, wherein
a teaching image of a region of the pointer in the second image is generated, and
the first model is trained by using the second image as input data and by using the teaching image as teacher data.

3. The training device according to claim 1, wherein
an indication in the second image is calculated, and
the first model is trained by using the second image as input data and by using the indication as teacher data.

4. The training device according to claim 1, wherein
the second image is deformed, and
the first model is trained using the deformed second image.

5. The training device according to claim 1, wherein
the generating of the second image includes:
acquiring a position of a region of the pointer and a position of a rotation center of the pointer in the first image;
erasing the pointer from the first image; and
rotating the pointer around the rotation center, and synthesizing the rotated pointer into the first image in which the pointer was erased.

6. The training device according to claim 1, wherein
the generating of the second image includes:
acquiring a position of a region of the pointer and a position of a rotation center of the pointer in the first image;
erasing the pointer from the first image;
rotating, around the rotation center, the first image in which the pointer was erased; and
synthesizing the erased pointer into the rotated first image.

7. The training device according to claim 1, wherein
a rotation range of the pointer is set based on a recognition result of the graduations of the meter, and
the second image is generated by relatively rotating the pointer with respect to the plurality of graduations within the rotation range.

8. The training device according to claim 1, wherein
the first model is trained using the first image.

9. The training device according to claim 1, wherein
a plurality of the second images is generated, and positions of the pointers are different from each other in the plurality of second images, and
the first model is sequentially trained using the plurality of second images.

10. A processing system, comprising:
the training device according to claim 1; and
a reading device that
extracts a pointer region, a scale region, and a character region from the first image, the pointer region including the pointer, the scale region including the graduations of the meter, the character region including a character of the meter, and
reads an indication of the meter in the first image based on the pointer region, the scale region, and the character region,
the training device generating the second image by using the pointer region extracted by the reading device.

11. The processing system according to claim 10, wherein
the first model identifies the pointer region according to an input of the meter image,
the training device calculates a first evaluation value of an accuracy of the first model, and
after the first evaluation value satisfies a first condition, the reading device reads the indication based on the scale region, the character region, and the pointer region identified by the first model.

12. The processing system according to claim 10, wherein
the training device also trains a second model that identifies an indication according to an input of a meter image,
the training device calculates a second evaluation value of an accuracy of the second model, and
after the second evaluation value satisfies a second condition, the reading device acquires the indication from an output of the second model.

13. A processing system,
the processing system reading an indication of a first image, and using a second image to train a first model that processes a meter image,
the second image being generated from the first image,
a meter being visible in the first image,
the meter including a pointer.

14. A training method, comprising:
using a first image to generate a second image, a meter being visible in the first image, the meter including a pointer, the pointer being rotated in the second image; and
using the second image to train a first model that processes a meter image.

15. The training method according to claim 14, wherein
the second image is deformed, and
the first model is trained by using the deformed second image.

16. A processing method, comprising:
the training method according to claim 14; and
a reading method including
extracting a pointer region, a scale region, and a character region from the first image, the pointer region including the pointer, the scale region including a graduation of the meter, the character region including a character of the meter, and
reading an indication of the meter in the first image based on the pointer region, the scale region, and the character region,
the training method generating the second image by using the pointer region extracted by the reading method.

17. A non-transitory computer readable storage medium storing a program,
the program causing a processing device to:
use a first image to generate a second image, a meter being visible in the first image, the meter including a pointer, the pointer being rotated in the second image; and
use the second image to train a first model that processes a meter image.

18. The storage medium according to claim 17, wherein
the program causes the processing device to:
deform the second image; and
use the deformed second image to train the first model.

19. The storage medium according to claim 17, wherein
the program causes the processing device to:
extract a pointer region, a scale region, and a character region from the first image, the pointer region including the pointer, the scale region including a graduation of the meter, the character region including a character of the meter;
read an indication of the meter in the first image based on the pointer region, the scale region, and the character region; and
use the extracted pointer region to generate the second image.
